(19) United States
(12) Patent Application Publication
(10) Pub. No.: US 2014/0373692 A1
(43) Pub. Date: Dec. 25, 2014

(54) LETTER OPENER WITH PROTECTED BLADE AND ROCKER

(71) Applicant: Markus Zeltner, Wädenswil (CH)

(72) Inventor: Markus Zeltner, Wädenswil (CH)

(21) Appl. No.: 14/284,417

(22) Filed: May 22, 2014

(30) Foreign Application Priority Data
Jun. 25, 2013 (CH) 01177/13

(51) Int. Cl. B43M 7/00

(52) U.S. Cl. CPC B43M 7/002
USPC 83/13; 30/294

(57) ABSTRACT

A letter opener comprises a housing which is sized to be conveniently held in one hand. An externally accessible groove extends along a side of the housing, the groove having an upper wall, a bottom wall, and a side wall. A blade partially protrudes into the groove through the upper wall at a distance from the side wall. A rocker is provided which can rotate around a rocker axis. The rocker comprises a front section forward of the rocker axis and a rear section rearward of the rocker axis. The front section of the rocker is arranged opposite the blade and, in use, pushes an envelope into the blade.

### TECHNICAL FIELD

The present invention belongs to the field of letter opening devices. More specifically, the present invention relates to a rocker-type letter opener.

### BACKGROUND

Letters are commonly opened by cutting an envelope with a knife-shaped device or tearing the envelope open by hand. There are also electric letter openers available in the market. Known methods and devices for opening letters are associated with various disadvantages and are not able to satisfy the need for a quick, easy and safe letter opening as each one of these methods and devices pose one or more problems.

Open blade-based devices, such as a knife, result in a relatively clean cut, but there is always a risk of injury. The insertion of a knife into an envelope fold can be tedious and the content of the envelope may be damaged. Tearing open a letter by hand is rather tedious and as the envelope is torn unevenly there is again the risk of damage to the contents. Electric letter openers are fast and produce a clean cut, but are expensive. Also, electric openers inherently require batteries or a power source to operate and hence tend to be rather large and cause ongoing operating expenses.

U.S. 2008/0104851 discloses a handheld letter opener that is capable of transitioning between an open and a closed position, having a blade that is exposed only when the letter opener is in the open position. U.S. 2005/028385 presents a handheld letter opener having a blade positioned within a groove, the blade being held in place by a spring. DE3614860 discloses a hand-held or table-top letter opener with replaceable blade, the blade being held between two separable housing parts. However, the devices described in these documents and similar such prior art are either too complicated to use and/or to manufacture, providing limited practical use for application in daily life. Further, none of these devices account for the fact that depending on the contents or paper an envelope can have different thicknesses, hardness, or resistance strength.

A problem in opening a letter concerns the placement of the blade at the letter's edge which offers the greatest resistance to a blade. For most of the letter openers, the blade is placed at the start of the edge of the letter opener. As a result, there is a danger that the blade, particularly when the blade is already somewhat dull, can be no longer able to cut through the envelope's edge. In this case, due to the force exerted by the blade on the envelope, the envelope might crumple (especially in case of thin paper) and make it impossible to open in a single, smooth motion. To solve this problem, partially movable mounted blades have been used in the prior art, such as CH590743 and FR2761298. However, these devices have inherent problems as they require more parts to spring-load the blade, making them more complicated to build and hence more expensive.

Another problem in opening a letter relates to the contact pressure with which the blade is pressed against the envelope's surface. Some openers cut through the entire envelope and separate a small top portion of the envelope, thus producing separate waste. Other openers utilize a mechanism which should ideally cut open only one side of the envelope, with the other side being intact and hence produce no separate waste. However, known devices with such mechanisms do not account for variation of paper thickness or hardness and hence fail, since a substantially constant force cannot achieve the same result with envelopes of different types of papers.

### SUMMARY

The present disclosure provides an improved hand-help letter opener, which allows opening a letter with a clean cut, slicing open only one layer of an envelope. The improved letter opener is cost-effective and easy to operate. It comprises a housing which is sized to be conveniently held in one hand. An externally accessible groove extends along a side of the housing, the groove having an upper wall, a bottom wall, and a side wall. A blade partially protrudes into the groove through the upper wall at a distance from the side wall. The groove is relatively small, so that the blade within is inaccessible for a human finger. A rocker is provided within the groove, the rocker being held by a rocker axis around which it can rotate. The rocker comprises a front section forward of the rocker axis and a rear section rearward of the rocker axis. The front section of the rocker is arranged opposite the blade and, in use, pushes an envelope into the blade. Consequently, the rocker axis is arranged rearward of the blade. The groove comprises an entry channel section and a cutting section, the rocker being arranged within the cutting section of the groove.

The rocker axis may be arranged substantially perpendicular to the side wall of the groove. The rocker axis may extend outwardly from the side wall of the groove, and may be attached to the side wall of the groove.

The housing may comprise a first housing component and a second housing component which are joined together. Alternatively, the housing may be formed as an integral component.

The letter opener may comprise a pressure arm arranged such that the rocker is disposed between the pressure arm and the side wall of the groove. In this case the rocker axis may be connected to the pressure arm. The pressure arm may be elastic, allowing the pressure arm to bend downward while opening thick envelopes.

The blade may be arranged substantially parallel to the side wall of the groove. Alternatively, the blade may be arranged such that the blade center line from the cutting edge of the blade to the trailing edge of the blade is at an angle between 0 to 15 degrees towards the side wall of the groove.

The letter opener is sized to be held in one hand, and may more specifically have a width of 4 to 10 cm, a height of 2 to 4 cm, and a depth of 1 to 3 cm. The blade may be interchangeable and the housing may comprise an opening for attaching the letter opener to a key chain or the like.

The position of the blade and the rocker are preferably coordinated, so that the front section of the rocker is at a distance from the blade that causes an upper layer of an envelope within the groove to be cut and a lower layer of the envelope to remain intact when the rocker assumes a substantially horizontal position parallel to the upper wall of the groove.

The disclosed letter opener is easy to use, requiring a user to only insert an envelope into the groove and slide the envelope through the groove along its side wall, e.g. by pulling the envelope with one hand while holding the letter opener in the other hand.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a perspective view of an exemplary letter opener.

FIG. 2 is a front view thereof.

FIG. 3 is a cross sectional view A-A thereof, showing the letter opener during the insertion of an envelope.

FIG. 4 shows the cross section A-A when the letter reaches the rocker and is pushed upwardly into the blade.

FIG. 5 shows the cross section A-A while an upper layer of the envelope is being cut with the rocker in a substantially horizontal position.

FIG. 6 shows the cross section A-A while cutting thin stationery.

FIG. 7 shows a cross sectional view B-B of the letter opener is in FIG. 2.

FIG. 8 is a perspective view of a second embodiment of a letter opener with a pressure arm.

FIG. 9 is an exploded perspective view of a third embodiment of letter opener.

FIG. 10 shows the exploded view as in FIG. 9 from a different perspective.

### DETAILED DESCRIPTION

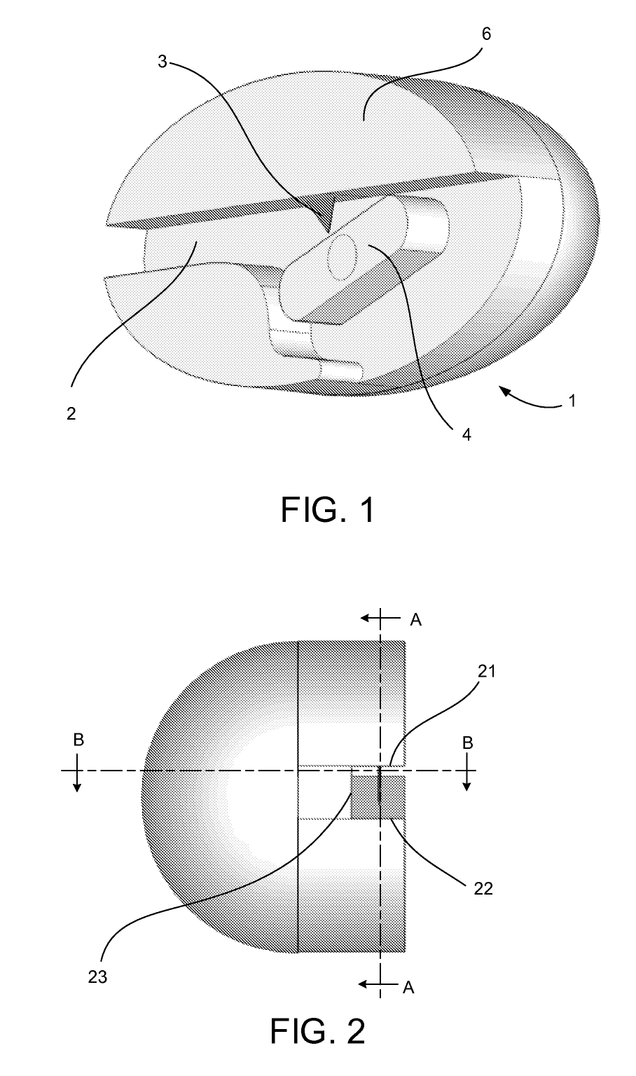

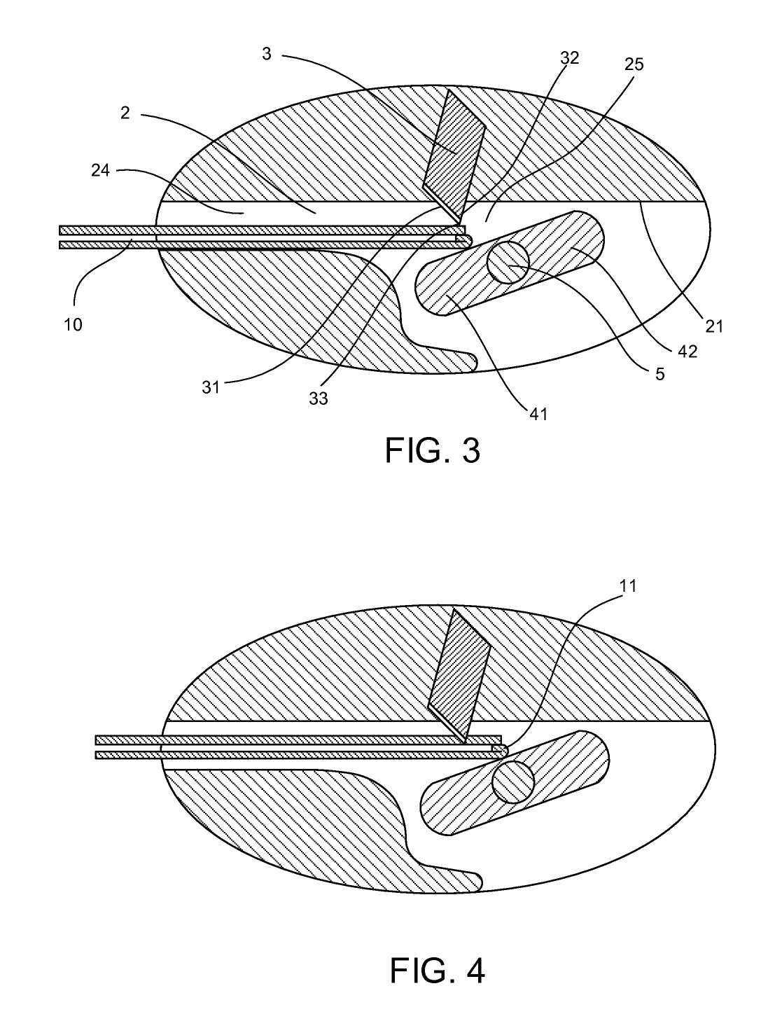

Referring to FIG. 1 and FIG. 3, a letter opener 1 comprises a housing 6 which is sized to be conveniently held in one hand and preferably has a width (w) of 4 to 10 cm, a height (h) of 2 to 4 cm and a depth (d) of 1 to 3 cm. Preferably the housing components 61 and 62 are of molded plastic.

A groove 2 extends along one side of the housing 6. The groove 2 comprises an upper wall 21, a bottom wall 22, and a side wall 23. The groove 2 is externally accessible for introducing and guiding an envelope 10 into an entry channel section 24 of the groove 2. Rearward of the entry channel section 24 the groove 2 widens into a cutting section 25. The upper wall 21 of the groove 2 extends substantially in a straight plane along both the entry channel section 24 and the cutting section 25 of the groove 2. The bottom wall 22 of the groove in the cutting section 25 is downwardly displaced relative to its position in the entry channel section 24. The entry channel section 24 of the groove 2 has an entry channel groove height between the bottom wall 22 and the upper wall 21 of about 5 mm.

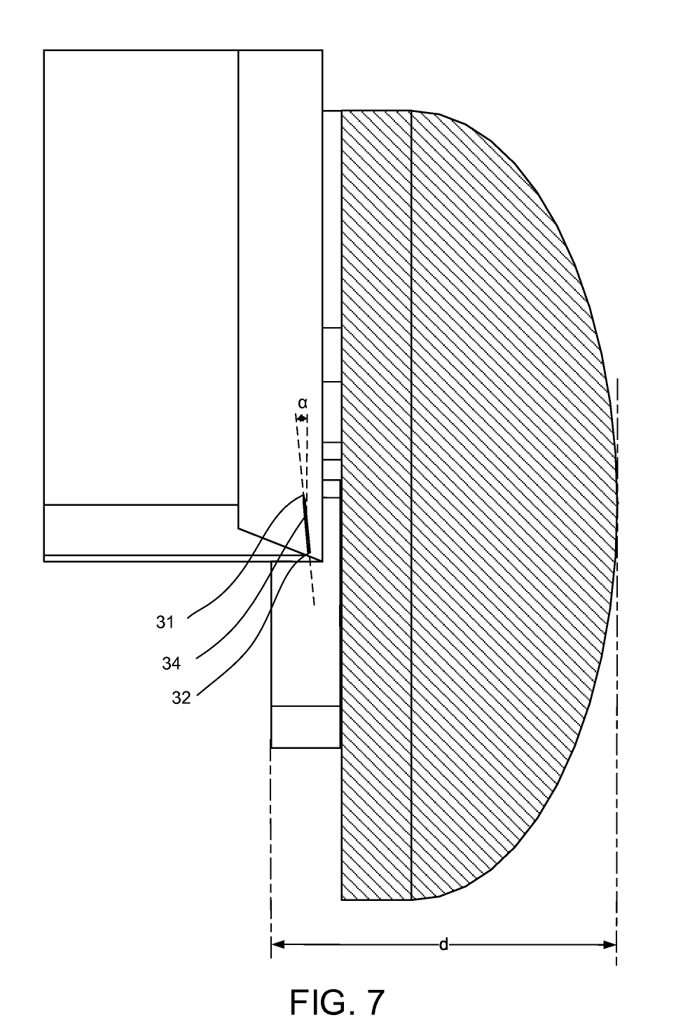

A blade 3 is mounted inside the cutting section 25 of the groove 2. The blade 3 protrudes partially into the groove 2 at a distance of about 1-3 mm from the side wall 23. The cutting edge 31 of the blade 3 is skewed backward at an angle of approximately 45°. The blade 3 may be arranged substantially parallel to the side wall 23 of the groove 2. Alternatively, as shown in FIG. 7, the blade 3 may be arranged such that the blade's center line from the cutting edge 31 of the blade 3 to the trailing edge 32 of the blade 3 is at an angle α relative to the side wall 23. The angle α should be preferably within the range of 0 to 15 degrees. The blade 3 may be interchangeably held between a first housing component 61 and a second housing component 62. The blade 3 may be made of metal, e.g. stainless steel or aluminum, or be made of ceramic. The blade 3 may be co-molded into the housing 6. The blade 3 may also be an integral molded, plastic extension of the first housing component 61. The blade 3 is recessed within the groove 2 to protect the blade 3 from accidental damage and inaccessible for a human finger to prevent accidental injury of a user.

The letter opener 1 further comprises a rocker 4 arranged within the cutting section 25 of the groove 2. The rocker 4 is attached to the side wall 23 of the groove 2 by a rocker axis 5. The rocker 4 comprises a front section 41 forward of the rocker axis and a rear section 42 rearward of the rocker axis 5. The rocker 4 can rotate within the cutting section 25 of the groove 2 about the rocker axis 5, the rocker axis 5 being arranged substantially perpendicular to side wall 23 of the groove 2. The tip 33 of the blade 3 is arranged forward of the rocker axis 5 and opposite the front section 41 of the rocker 4.

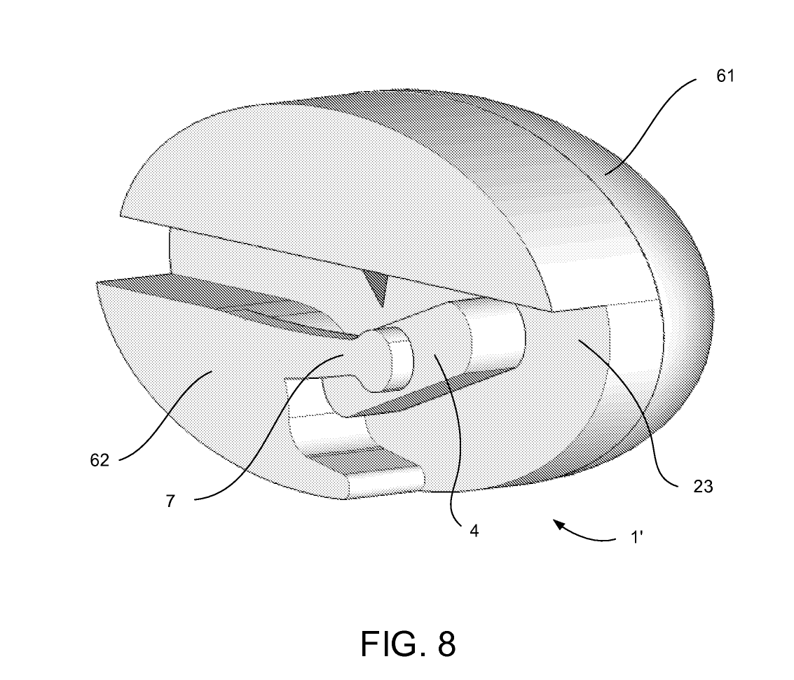

Referring now to FIG. 8 a second embodiment of a letter opener 1′ is shown. The letter opener 1′ comprises a pressure arm 7 which is connected to or formed as an integral part of the second housing component 62 and reaches over the cutting section 25 of the groove 2. In this second embodiment the rocker 4 is disposed between the side wall 23 and the pressure arm 7. The rocker axis 5 is connected to the pressure arm 7. The pressure arm 7 may be made of an elastic material such as polyethylene. The use of an elastic pressure arm 7 allows use of the letter opener 1′ with very thick envelopes, as the pressure arm 7 can be bent downward to accommodate even thick envelopes.

A method of opening an envelope 10 using the letter opener 1 is illustrated in FIG. 3 through 5, which show phases of the opening process. The letter opener 1 is preferably pocket-sized and can be easily held in one hand by a user. To open the envelope 10, a user may hold the letter opener 1 in one hand and hold the envelope 10 in the other hand. An edge of the envelope 10, hereafter referred to as the leading edge 11, is inserted into the entry channel section 24 of the groove 2 such that the envelope 10 slides along the side wall 23. The envelope 10 is pushed forward until its leading edge 11 reaches the blade 3 as shown in FIG. 1. During this insertion phase the envelope 10 can easily slide under the tip 33 of the blade 3, as the front section 41 of the rocker 4 moves downward away from the blade 3.

As the envelope 10 moves further along the groove 2, the leading edge of the envelope 10 slides on the rocker 4 until the blade 3 penetrates the upper layer of the envelope 10, as shown in FIG. 4.

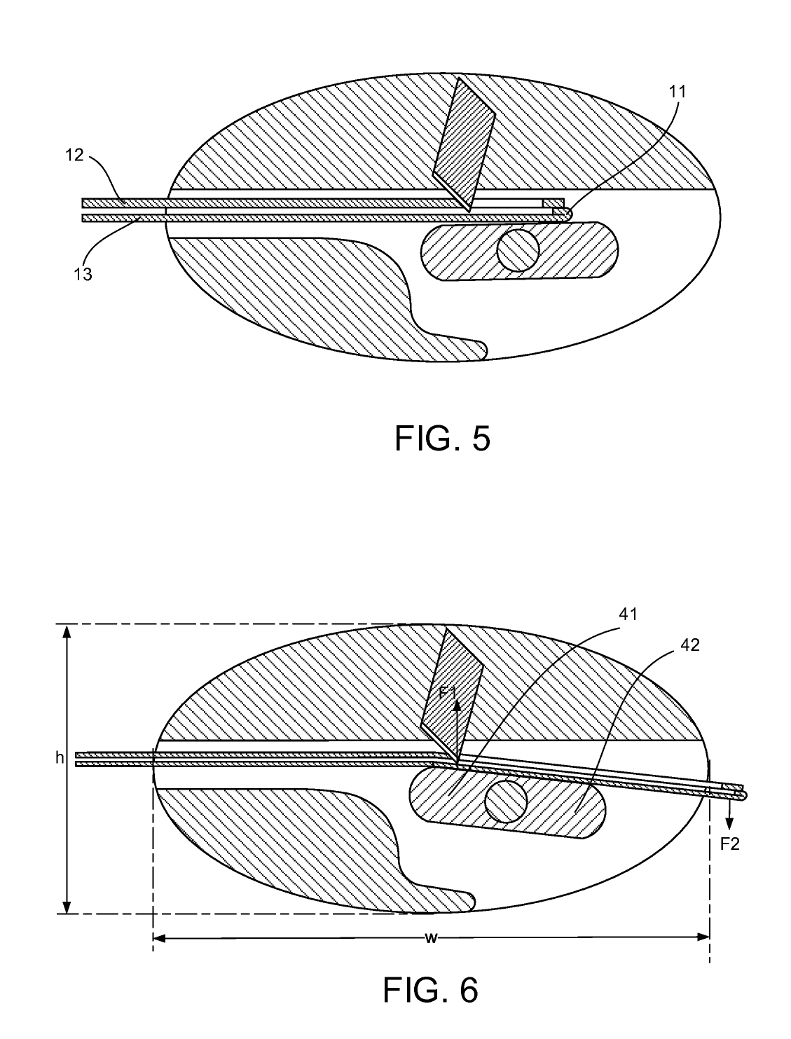

Once the leading edge 11 of the envelope 10 moves past the rocker axis 5, the rocker 4 assumes a substantially horizontal position and pushes the envelope 10 into the blade 3. Contrary to many other letter openers, the envelope 10 is thus not cut immediately at its leading edge 11, but rearward thereof after the leading edge 11 of the envelope 10 has passed the rocker axis 5. The relative placement of the blade 3, the rocker 4 and the rocker axis 5 are coordinated such, that when the rocker 4 assumes a substantially horizontal position it provides an optimal pressing force for cutting the envelope 10. As shown in FIG. 5, this optimal pressing force is selected such that the upper layer 12 of the envelope 10 is cut, while the lower layer 13 of the envelope 10 remains unharmed.

As illustrated in FIG. 6, a user may choose to pull the leading edge 11 of the envelope 10 forward and slightly downward. The downward component of the pulling force exerted by the user is indicated by the arrow F2. By doing so the rear section 42 of the rocker 4 is pulled downward and consequently the front section 41 of the rocker 4 moves upward towards the blade 3, thus increasing the pressing force F1 with which the envelope 10 is pushed towards the blade 3. This allows a user to open letters which use harder than average or thinner than average paper, which may e.g. be the case with airmail envelopes. Increasing the pressing force may also help compensate for dullness of the blade 3 which may occur over time. As shown the lever arm from the tip 33 of the blade 3 to the rocker axis 5 is much shorter than the lever arm from the rocker axis 5 to the leading edge 11 of the envelope 10 which is held by the user. Consequently, a relatively small force F2 exerted by the user results in a much larger pressing force F1 with which the envelope 10 is pushed into the blade 3.

As shown in FIG. 7, the blade 3 may be arranged such that the blade's center line 34 from the cutting edge 31 of the blade 3 to the trailing edge 32 of the blade 3 is at an angle α relative to the side wall 23. Biasing the blade 3 with an angle α causes the envelope 10 to be pulled towards the side wall 23 of the groove 2 as it slides past the blade 3, which support the user in guiding the envelope 10 through the groove 2.

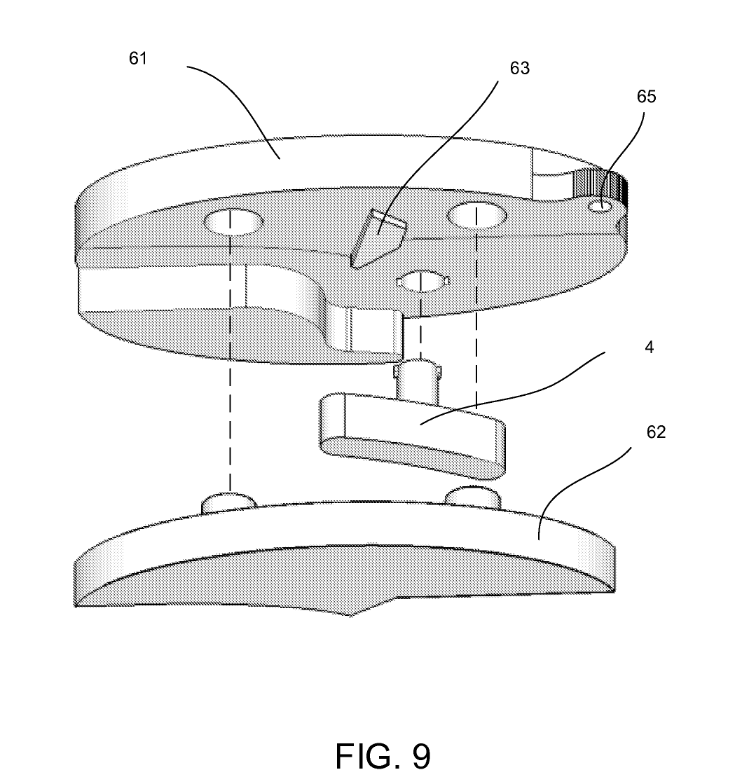

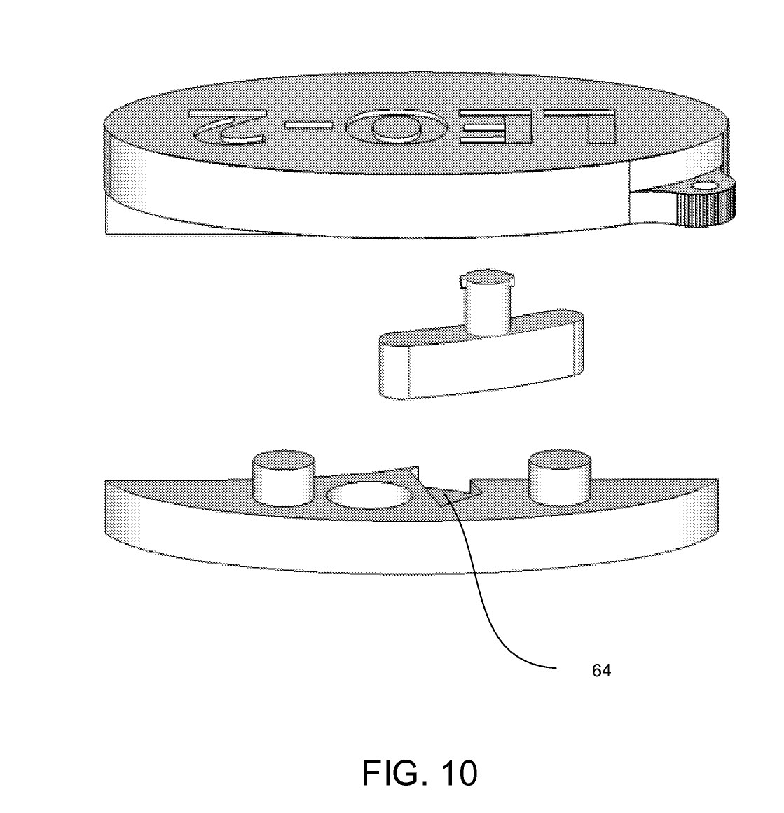

FIG. 9 and FIG. 10 show an exploded view of a third embodiment of an exemplary letter opener. The housing 6 comprises a first housing component 61 which is connected to a second housing component 62. A blade 3 (not shown) is held within a blade recess 64 of the second housing component 62 and secured by a corresponding protrusion 63 in the first housing component 61. The blade 3 may be replaced by separating the first housing component 61 from the second housing component 62. Alternatively, housing 6 may be an integral part and the blade 3 may be molded into the housing 6. The housing 6 comprises an opening 65 for attaching the housing 6 to a keychain or the like.

An advantage of the present invention is that the user can pull an envelope through the groove 2, while the rocker 4 creates a pressing force F1 which pushes the envelope 10 towards the blade 3. This pressing force F1 is substantially perpendicular to the pulling force of the user, resulting in a clean cut while avoiding torques that could lead to crumpling of the paper of the envelope 10.

A further advantage is that the housing 6 protects the blade 3 while preventing any injuries to the hand of a user due to coming in contact with the blade 3 during the letter opening process. Yet another advantage is that only the upper layer 12 of the envelope 10 gets cut and thus remains connected and can be disposed of together with the envelope 10, resulting in no separate waste.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A letter opener, comprising:
a housing;
an externally accessible groove extending along a side of the housing, the groove having an upper wall, a bottom wall, and a side wall;
a blade which partially protrudes into the groove through the upper wall at a distance from the side wall; and
a rocker which rotates about a rocker axis, the rocker having a front section forward of the rocker axis and a rear section rearward of the rocker axis,
wherein the front section of the rocker is arranged opposite the blade.

2. The letter opener as in claim 1, wherein the rocker axis is arranged substantially perpendicular to the side wall of the groove.

3. The letter opener as in claim 2, wherein the rocker axis is arranged rearward of the blade.

4. The letter opener as in claim 1, wherein the rocker axis extends outwardly from the side wall of the groove.

5. The letter opener as in claim 1, wherein the rocker axis is attached to the side wall of the groove.

6. The letter opener as in claim 1, wherein the housing comprises a first housing component and a second housing component which are joined together.

7. The letter opener as in claim 6, wherein the second housing comprises a pressure arm and wherein the rocker is disposed between the pressure arm and the bottom wall of the groove.

8. The letter opener as in claim 7, wherein the rocker axis is connected to the pressure arm.

9. The letter opener as in claim 8, wherein the pressure arm is elastic, thereby allowing the pressure arm to bend downward while opening thick envelopes.

10. The letter opener as in claim 1, wherein the blade is arranged substantially parallel to the side wall of the groove.

11. The letter opener as in claim 1, wherein the blade is arranged such that a blade center line from a cutting edge of the blade to a trailing edge of the blade is at an angle between 0 to 15 degrees towards the side wall of the groove.

12. The letter opener as in claim 1, wherein the housing has a width of 4 to 10 cm, a height of 2 to 4 cm, and a depth of 1 to 3 cm.

13. The letter opener as in claim 1, wherein the blade is interchangeable.

14. The letter opener as in claim 1, wherein the housing comprises an opening for attaching the letter opener to a key chain or the like.

15. The letter opener as in claim 1,
wherein the groove comprises an entry channel section and a cutting section,
and wherein the rocker is arranged within the cutting section.

16. The letter opener as in claim 1, wherein the front section of the rocker is at a distance from the blade that causes an upper layer of an envelope within the groove to be cut and a lower layer of the envelope to remain intact when the rocker assumes a substantially horizontal position parallel to the upper wall of the groove.

17. A method for opening an envelope with the letter opener as in claim 1, comprising the steps of inserting the envelope into the groove and moving the envelope through the groove.

18. The method as in claim 17, wherein an upper layer of the envelope is cut rearward of a leading edge of the envelope.

19. The method as in claim 18, wherein a lower layer of the envelope is not cut.
